(19) United States
(12) Patent Application Publication
(10) Pub. No.: US 2017/0154627 A1
(43) Pub. Date: Jun. 1, 2017

(54) METHOD FOR USING A HUMAN-MACHINE INTERFACE DEVICE FOR AN AIRCRAFT COMPRISING A SPEECH RECOGNITION UNIT

(71) Applicant: THALES, Courbevoie (FR)

(72) Inventors: Francois MICHEL, Merignac (FR); Stephanie Lafon, Martignas en Jalle (FR); Jean-Baptiste Bernard, Le Haillan (FR)

(21) Appl. No.: 15/360,888

(22) Filed: Nov. 23, 2016

(30) Foreign Application Priority Data
Nov. 27, 2015 (FR) 1502480

(51) Int. Cl. G10L 15/22; G10L 15/10

(52) U.S. Cl. CPC G10L 15/22; G10L 15/10; G06F 3/0488

(57) ABSTRACT

The general field of the invention is that of methods for using a human-machine interface device for an aircraft comprising at least one speech recognition unit, one display device with a touch interface, one graphical interface computer and one electronic computing unit, the set being designed to graphically present a plurality of commands, each command being classed in at least a first category, referred to as the critical category, and a second category, referred to as the non-critical category, each non-critical command having a plurality of options, each option having a name, said names assembled in a database called a “lexicon”. The method according to the invention comprises steps of recognizing displayed commands, activating the speech recognition unit, comparing the touch and voice information and a validation step.

The field of the invention is that of human-machine interactions in the cockpit of an aircraft and, more specifically, that of systems comprising a voice command device and a touch device.

In modern cockpits, interactions between the pilot and the aircraft take place by means of various human-machine interfaces. The main ones occur via interactions with instrument panel display devices which display the main flight and navigation parameters required for the flight plan to be carried out smoothly or for the mission to be executed. Increasingly, touch surfaces, which allow simple interactions with display devices, are used to this end.

In order to further simplify the pilot's interactions with the onboard system, it is possible to use speech as a means for interacting via a voice recognition system.

Voice recognition has been studied experimentally in the field of avionics. In order to guarantee recognition that is compatible with use in an aeronautical environment, which may be noisy, solutions based on a limited dictionary of commands and on user prior learning have been implemented. Furthermore, these solutions require the use of a push-to-talk device, for example a physical button in the cockpit, which allows voice recognition to be triggered or stopped.

It is also possible to use a touch surface in order to trigger voice recognition. Thus, the application WO2010/144732, entitled “Touch anywhere to speak”, describes a system for mobile electronic devices triggering voice recognition through touch interaction. This application makes no mention of the safety aspects specific to the field of aeronautics and does not propose any solutions for improving the reliability of voice recognition in noisy environments.

Thus, the current solutions require a physical push-to-talk device, pilot learning of the list of commands available through voice recognition and a system for acknowledging the result. Moreover, the levels of performance from voice recognition generally limit its use.

The method for using a human-machine interface device for an aircraft comprising a speech recognition unit according to the invention does not have these drawbacks. It makes it possible:
to limit tedious touch interactions, such as typing on a virtual keyboard, which lead to errors or annoyance particularly in the event of atmospheric turbulence;
to provide a level of safety compatible with aeronautical standards on the use of voice recognition;
to limit pilot learning of the voice command dictionary by placing the voice command within a specific and limited context, thus considerably decreasing the risk of errors.

It also ensures, in a simple manner, the management of critical commands and non-critical commands. The term “critical command” is understood to mean a command liable to endanger the safety of the aircraft. Thus, starting or stopping the engines is a critical command. The term “non-critical command” is understood to mean a command having no significant impact on flight safety or the safety of the aircraft. Thus, changing a radiocommunication frequency is not a critical command.

More specifically, the subject of the invention is a method for using a human-machine interface device for an aircraft comprising at least one speech recognition unit, one display device with a touch interface, one graphical interface computer and one electronic computing unit, the set being designed to graphically present a plurality of commands, each command being classed in at least a first category, referred to as the critical category, and a second category, referred to as the non-critical category, each non-critical command having a plurality of options, each option having a name, said names assembled in a database called a “lexicon”, characterized in that:
when the command is critical, the method of use comprises the following steps:
   recognizing the critical command activated by a user by means of the touch interface;
   activating the speech recognition unit depending on said command;
   comparing the speech decoded by the speech recognition unit with the activated command;
   validating the activated command if the decoded speech corresponds to the activated command;
when the command is non-critical, the method of use comprises the following steps:
   recognizing the non-critical command activated by a user by means of the touch interface;
   activating the speech recognition unit depending on said command;
   comparing the speech decoded by the speech recognition unit with the names in the lexicon associated with the activated command;
   selecting the name in the lexicon that best corresponds to the decoded speech;
   displaying the option corresponding to said name in the lexicon.

Advantageously, when the command is non-critical, the option corresponding to the name in the lexicon is automatically implemented.

Advantageously, the function for activating the speech recognition unit is active only for a limited duration starting from the time at which the command activated by a user by means of the touch interface is recognized.

Advantageously, this duration is proportional to the size of the lexicon.

Advantageously, this duration is less than or equal to 10 seconds.

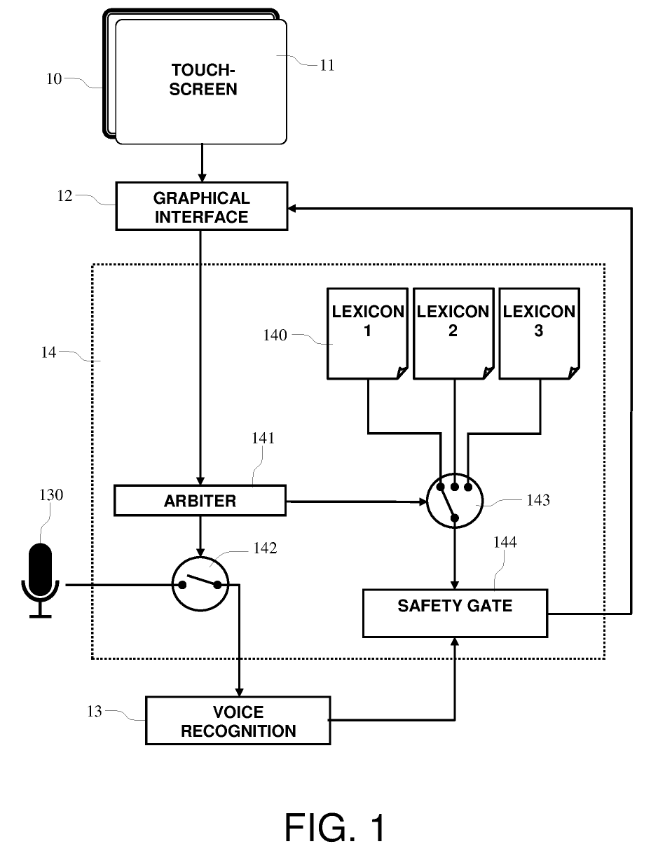

The invention will be better understood and other advantages will become apparent upon reading the following non-limiting description and by virtue of the appended FIG. 1, which shows the overview of a human-machine interface device for an aircraft according to the invention.

The method according to the invention is implemented in a human-machine interface device for an aircraft and, more specifically, in its electronic computing unit.

By way of example, the set of means of the human-machine interface device 1 is shown in FIG. 1. It comprises at least:
one display device 10 with a touch interface 11;
one graphical interface computer 12;
one speech recognition unit 13;
one electronic computing unit 14. This unit is surrounded by a dotted line in FIG. 1.

The display device 10 is conventionally a liquid crystal flat screen. Other technologies may be envisaged. It presents flight or navigation information, or information on the avionics system of the aircraft. The touch interface 11 takes the form of a transparent touchpad positioned on the screen of the display device. This touchpad is akin to the touchpads implemented on tablets or smartphones intended for the general public. Multiple technical solutions, well known to those skilled in the art, allow this type of touchpad to be produced.

The graphical interface 12 is a computer which, from various data arising from the sensors or from the databases of the aircraft, generates the graphical information sent to the display device. This information comprises a certain number of commands. Each command has a certain number of possible options. For example, the “transmission frequency” command has a certain number of possible frequency options.

The graphical interface 12 also retrieves information arising from the touchpad which is converted into command or validation instructions for the rest of the avionics system.

The speech recognition unit 13 conventionally comprises a microreceiver 130 and speech processing means allowing the words uttered by a user to be recognized. Here again, these various means are known to those skilled in the art. This unit is configurable in the sense that the lexicons of commands/words to be recognized can be specified thereto at any time.

The speech recognition unit is active only for a limited duration starting from the time at which the command activated by a user by means of the touch interface is recognized. The triggering and stopping of voice recognition is therefore a smart mechanism:
the voice command is triggered via touch interaction allowing a pilot to determine the object to be modified;
the duration of recognition is determined either by the end of the first touch interaction, or, depending on the lexicon, upon detection of a recognition in accordance with the lexicon. There is also a limit duration that depends on the selected lexicon and which prevents voice recognition from remaining active indefinitely if, for example, the end of the touch interaction is not detected. The value of this duration depends on the selected lexicon. This duration is generally less than or equal to 10 seconds.

For non-critical commands, the electronic computing unit 14 comprises a certain number of databases, referred to as “lexicons” 140. Each lexicon comprises words or names corresponding to a particular command option. Thus, the “Frequency” command comprises only names indicative of frequency or frequency values. FIG. 1 comprises, by way of non-limiting example, three databases called “Lexicon 1”, “Lexicon 2” and “Lexicon 3”.

The electronic computing unit 14 carries out the following specific tasks:
“arbiter” 141. This terms covers two functions.
   The first function 142 consists of activating/deactivating voice recognition. It is symbolically represented by a two-way switch in FIG. 1. The aim of this function is to activate voice recognition only when the user selects a command via the touchpad, i.e. at the appropriate time.
   The second function 143 consists of specifying the right lexicon of commands or of words to be recognized depending on the command. In plain language, the selected lexicon, which corresponds to lexicon 1 in FIG. 1, corresponds to the options of a single command. This function 143 is symbolically represented by a multi-way switch in FIG. 1;
“security gate” 144. This function verifies that the result of the voice command is indeed in accordance with the lexicon selected by the arbiter 141 and transmits it to the graphical interface 12 if this accordance is obtained. The graphical interface then displays a confirmation or validation request to the pilot.

As stated above, there are two types of command, referred to as critical and non-critical commands.

By way of first example, in order to illustrate the operation of the human-machine interface according to the invention in the case of a critical command, it is supposed that a fire has broken out on the left engine and the pilot wishes to stop this engine.

By pressing a virtual button displayed on the touch interface which allows the left engine to be stopped, the pilot must simultaneously utter “stop left engine” while continuing to press the button for stopping the left engine. The action is validated by the system only if the phrase “stop left engine” is recognized by the speech recognition unit.

By way of second example, in order to illustrate the operation of the human-machine interface according to the invention in the case of a non-critical command, it is supposed that the graphical interface is displaying a radio frequency and the pilot wishes to change this frequency.

On a display screen of the cockpit, the current value of said radio frequency for VHF communications is displayed. The pilot pressing the touchpad at the position of the representation of this frequency triggers voice recognition for a determined duration and selects the lexicon allowing radio frequencies to be recognized. This lexicon comprises, for example, a set of particular values. Since the pilot has designated a frequency, he or she can naturally utter a new value for the frequency; voice recognition carries out an analysis according to the lexicon restricted to the possible frequencies. If the recognized word appears in the lexicon, then the gate 144 proposes a text value which is displayed in proximity to the current value. The pilot may or may not validate the new value through a second touch interaction. Validation may also be automatic when the new choice does not entail any negative consequences.

This human-machine interface has the following advantages.

The first advantage is the safety of the device in the case of both critical commands and non-critical commands. Safety is an essential feature of interfaces intended for aeronautical applications. First, voice recognition is restricted to a particular context, the recognition of a frequency in the preceding example, which makes it possible to guarantee a higher level of safety for the device than for devices operating blind. Furthermore, touch information and voice recognition are redundant. Lastly, by limiting the time for which voice recognition is active, unintentional recognitions are avoided and the result of the command can be verified with respect to possible values.

The second advantage is the wider range of options of the device. The combination of touch and voice recognition allows a greater number of commands to be recognized while making the use of voice recognition safe. Specifically, instead of a single lexicon of words to be recognized, voice recognition is based on a plurality of lexicons. Each of these lexicons is of limited size but the sum of these lexicons makes a large number of command options possible.

The third advantage is the highly ergonomic nature of the device. Specifically, the designation of the object to be modified allows the pilot to intuitively know the nature of the voice command to be issued and therefore decreases the learning required by the voice command. Moreover, the selection of the right lexicon and voice recognition are intuitively triggered via a touch interaction on a element of the human-machine interface of the cockpit. This device thus allows the pilot to interact intuitively and efficiently with the onboard system since touch is used to designate the parameter to be modified and voice is used to give the new value.

The fourth advantage is doing away with a physical “push-to-talk” device, i.e. means for starting and stopping voice recognition. This push-to-talk device is most commonly a mechanical control button. In the device according to the invention, starting and stopping is achieved intelligently, solely when voice recognition must be called upon.

1. A method for using a human-machine interface device for an aircraft comprising at least one speech recognition unit, one display device with a touch interface, one graphical interface computer and one electronic computing unit, the set being designed to graphically present a plurality of commands, each command being classed in at least a first category, referred to as the critical category, and a second category, referred to as the non-critical category, each non-critical command having a plurality of options, each option having a name, said names assembled in a database called a “lexicon”,
wherein:
when the command is critical, the method of use comprises:
recognizing the critical command activated by a user by means of the touch interface;
activating the speech recognition unit depending on said command;
comparing the speech decoded by the speech recognition unit with the activated command;
validating the activated command if the decoded speech corresponds to the activated command;
when the command is non-critical, the method of use comprises:
recognizing the non-critical command activated by a user by means of the touch interface;
activating the speech recognition unit depending on said command;
comparing the speech decoded by the speech recognition unit with the names in the lexicon associated with the activated command;
selecting the name in the lexicon that best corresponds to the decoded speech;
displaying the option corresponding to said name in the lexicon.

2. The method for using a human-machine interface device according to claim 1, wherein, when the command is non-critical, the option corresponding to the name in the lexicon is automatically implemented.

3. The method for using a human-machine interface device according to claim 1, wherein the function for activating the speech recognition unit is active only for a limited duration starting from the time at which the command activated by a user by means of the touch interface is recognized.

4. The method for using a human-machine interface device according to claim 3, wherein this duration is proportional to the size of the lexicon.

5. The method for using a human-machine interface device according to claim 3, wherein this duration is less than or equal to 10 seconds.
